(19) United States
(12) Patent Application Publication
(10) Pub. No.: US 2026/0024526 A1
(43) Pub. Date: Jan. 22, 2026

(54) VEHICLE USER INTERFACE AND CONTROL SYSTEM USING LARGE LANGUAGE MODELS

(71) Applicant: GM GLOBAL TECHNOLOGY OPERATIONS LLC, Detroit, MI (US)

(72) Inventors: Gaurav TALWAR, Novi, MI (US); Kenneth Ray BOOKER, Grosse Pointe Woods, MI (US); Dnyanesh G. RAJPATHAK, Troy, MI (US)

(21) Appl. No.: 18/773,821

(22) Filed: Jul. 16, 2024

(51) Int. Cl. G10L 15/197; G06F 3/16; G10L 15/06; G10L 15/22; G10L 25/63

(52) U.S. Cl. CPC G10L 15/197; G06F 3/167; G10L 15/063; G10L 15/22; G10L 25/63; G10L 2015/0635; G10L 2015/223

(57) ABSTRACT

A vehicle user interface system includes a vehicle speaker configured to generate audio signals, a vehicle user interface, a vehicle microphone configured to capture speech of a vehicle occupant, and a vehicle control module configured to obtain speech input from the vehicle occupant, classify the speech input as a deterministic speech request or a probabilistic speech request, process the speech input using a statistical language model (SLM) to generate an SLM output in response to a deterministic speech request, process the speech input using a large language model (LLM) to generate an LLM output in response to a probabilistic speech request, and generate an audio response output or a textual response based on the SLM output generated by the statistical language model or the LLM output generated by the large language model.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to vehicle user interfaces and control systems using large language models.

Some vehicles include voice control features, where a driver or passenger may provide speech requests or commands to obtain information via a vehicle user interface, or to control one or more functions of a vehicle. Separately, large language models (LLMs) are used to generate responses to user voice requests.

### SUMMARY

A vehicle user interface system includes at least one vehicle speaker configured to generate audio signals within a vehicle, a vehicle user interface including a screen configured to display text, at least one vehicle microphone configured to capture speech of a vehicle occupant, and a vehicle control module configured to obtain speech input from the vehicle occupant via the at least one vehicle microphone, classify the speech input as a deterministic speech request or a probabilistic speech request, in response to the speech input being classified as a deterministic speech request, process the speech input using a statistical language model (SLM) to generate an SLM output, in response to the speech input being classified as a probabilistic speech request, process the speech input using a large language model (LLM) to generate an LLM output, generate at least one of an audio response output using the at least one vehicle speaker or a textual response output using the screen of the vehicle user interface, wherein the audio response output or the textual response output is based on the SLM output generated by the statistical language model or the LLM output generated by the large language model.

In some examples, the vehicle control module is configured to automatically modify operation of at least one vehicle component in response to the speech input including an occupant request to operate the at least one vehicle component.

In some examples, automatically modifying operation of the at least one vehicle component includes at least one of initiating a phone call through the vehicle user interface, sending a message through the vehicle user interface, activating an entertainment function of the vehicle user interface, or changing at least one driving setting of the vehicle.

In some examples, the vehicle control module is configured to calculate a confidence score for the LLM output of the large language model, compare the confidence score to a specified confidence score threshold indicative of an accurate LLM output likelihood, and generate the audio response output or the textual response output based on the SLM output in response to the confidence score being below the specified confidence score threshold.

In some examples, calculating the confidence score for the LLM output includes comparing embeddings of tokens of the LLM output to embeddings of the SLM output of the statistical language model.

In some examples, the specified confidence score threshold is a first confidence score threshold, and the vehicle control module is configured to compare the confidence score to a second confidence score threshold, the second confidence score threshold greater than the first confidence score threshold, and generate the audio response output or the textual response output based on a combination of the LLM output and the SLM output in response to the confidence score being greater than the first confidence score threshold and below the second confidence score threshold.

In some examples, the vehicle control module is configured to update a database of corrected output labels, based on the SLM output of the statistical language model, in response to the confidence score being below the specified confidence score threshold, and retrain the large language model using the database of corrected output labels.

In some examples, the vehicle control module is configured to obtain model output guardrail data from a database of stored sensitive output topic data, process the speech input using the large language model (LLM) to generate an interim output response, compare the interim output response to the model output guardrail data, and inhibit output of the interim output response in response to the interim output response including a disallowed topic of the model output guardrail data.

In some examples, the vehicle control module is configured to obtain a current geographic location of the vehicle, the stored sensitive output topic data in the database varies by geographic location, and comparing the interim output response to the model output guardrail data includes comparing the interim output response to only sensitive output topic data corresponding to the current geographic location of the vehicle.

In some examples, the vehicle control module is configured to determine a vehicle occupant emotion score based on the speech input obtained from the vehicle occupant, compare the vehicle occupant emotion score to a specified emotion score threshold indicative of vehicle occupant frustration of interacting with output of the large language model, and generate the audio response output or the textual response output based on the SLM output instead of the LLM output in response to the vehicle occupant emotion score exceeding the specified emotion score threshold.

In some examples, determining the vehicle occupant emotion score includes generating a first vehicle occupant emotion score based on textual processing of the speech input, generating a second vehicle occupant emotion score based on acoustic processing of the speech input, and combining the first vehicle occupant emotion score and the second vehicle occupant emotion score to generate an overall vehicle occupant emotion score.

In some examples, the vehicle control module is configured to convert audio signals of the speech input to text using automatic speech recognition (ASR).

A method of operating a vehicle user interface system includes obtaining speech input from a vehicle occupant using at least one vehicle microphone, classifying the speech input as a deterministic speech request or a probabilistic speech request, in response to the speech input being classified as a deterministic speech request, processing the speech input using a statistical language model (SLM) to generate an SLM output, in response to the speech input being classified as a probabilistic speech request, processing the speech input using a large language model (LLM) to generate an LLM output, and generating at least one of an audio response output using at least one vehicle speaker or a textual response output using a screen of a vehicle user interface, wherein the audio response output or the textual response output is based on the SLM output generated by the statistical language model or the LLM output generated by the large language model.

In some examples, the method includes automatically modifying operation of at least one vehicle component in response to the speech input including an occupant request to operate the at least one vehicle component.

In some examples, automatically modifying operation of the at least one vehicle component includes at least one of initiating a phone call through the vehicle user interface, sending a message through the vehicle user interface, activating an entertainment function of the vehicle user interface, or changing at least one driving setting of the vehicle.

In some examples, the method includes calculating a confidence score for the LLM output of the large language model, comparing the confidence score to a specified confidence score threshold indicative of an accurate LLM output likelihood, and generating the audio response output or the textual response output based on the SLM output in response to the confidence score being below the specified confidence score threshold.

In some examples, calculating the confidence score for the LLM output includes comparing embeddings of tokens of the LLM output to embeddings of the SLM output of the statistical language model.

In some examples, the specified confidence score threshold is a first confidence score threshold, and the method further includes comparing the confidence score to a second confidence score threshold, the second confidence score threshold greater than the first confidence score threshold, and generating the audio response output or the textual response output based on a combination of the LLM output and the SLM output in response to the confidence score being greater than the first confidence score threshold and below the second confidence score threshold.

In some examples, the method includes updating a database of corrected output labels, based on the SLM output of the statistical language model, in response to the confidence score being below the specified confidence score threshold, and retraining the large language model using the database of corrected output labels.

In some examples, the method includes obtaining model output guardrail data from a database of stored sensitive output topic data, processing the speech input using the large language model (LLM) to generate an interim output response, comparing the interim output response to the model output guardrail data, and inhibiting output of the interim output response in response to the interim output response including a disallowed topic of the model output guardrail data.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a vehicle including a vehicle user interface and a large language model;

FIG. 2 is a functional block diagram of multiple language models for use with the vehicle user interface of FIG. 1;

FIG. 3 is a flowchart depicting an example process for automated control of vehicle components based on user requests;

FIG. 4 is a flowchart depicting an example process for processing user speech using a large language model or a statistical language model;

FIG. 5 is a flowchart depicting an example process for comparing confidence scores of a large language model and a statistical language model;

FIG. 6 is a flowchart depicting an example process for using guardrail data to restrict output of a large language model;

FIG. 7 is a flowchart depicting an example process for selecting between a large language model and a statistical language model based on output confidence scores;

FIG. 8 is a flowchart depicting an example process for processing speech including performing acoustic emotion classification;

FIGS. 9A and 9B are graphical representations of example neural networks for generating responses to user speech; and

FIG. 10 is a flowchart illustrating an example process for training a machine learning model.

In the drawings, reference numbers may be reused to identify similar and/or identical elements.

### DETAILED DESCRIPTION

Some example embodiments described herein provide vehicle user interfaces configured to inhibit or prevent generative artificial intelligence (AI) models from outputting inappropriate content, which may include hallucinations. Example systems may implement large language models (LLMs) in combination with a natural language understanding model, such as a statistical language model (SLM).

For example, a statistical language model and semantic classifier may be used to classify context, topics and entities from user speech, such as a driver or passenger of a vehicle. Some examples may utilize confidence-based heuristics to facilitate or ensure that a large language model is confident in its predictions or outputs, and to arbitrate selection of output from a natural language processing (NLP) model. The NLP model may be used as a robust baseline to check results output by the LLM, and overall confidence may be estimated for an output prompt (e.g., a textual or audio response to the user from the model).

A user request (e.g., via voice or textual input to a vehicle user interface or mobile device) may be arbitrated as a deterministic request or probabilistic request. This determination allows the system to direct user speech or input to a large language model (LLM), and/or to a statistical language model, for further processing. For example, deterministic requests such as “end call” or “turn on radio” may be more easily handled by a deterministic SLM, while more complex requests such as “find fast food restaurants near zip code 600XX” may be more easily handled by a probabilistic LLM.

A vehicle control modules may be configured to decide which type of model to use based on semantic classification, a keyword or topic based ruleset, etc. Requests that are beyond a predefined set of deterministic (e.g., ecosystem) categories may be put into a fallback context and be routed to the large language model.

Large language models do not output a confidence score like some other automated speech recognition results. In some examples herein, probability scores may be computed for an output prompt generated by a large language model, by summation of individual tokens and normalization. For example, computing the likelihood probability (e.g., confidence score) for LLM output may include summation of conditional probabilities of individual tokens in the sequence, and then normalizing the conditional probabilities by a count of tokens. This may provide a new quantification method for LLMs to provide corresponding confidence scores, such as using the equation ΣP(Utterance/Context) i=1:N/N.

A confidence threshold may be established, for example, based on a task-completion oriented training set that is initially vetted by a statistical language model. The vehicle control module may be configured to compare the LLM output confidence scores with the specified confidence threshold, to decide if the large language model is confident enough to relay the result to the user.

The SLM verified utterances may be used for task completion conditioning of the large language model. For example, a training set may be used to optimize the large model, by optimizing criteria of minimizing the training loss function (e.g., where information theory metrics such as cross entropy are used for the same).

The LLM result may be rewarded or penalized by matching intents and entity sets with the corresponding result from Natural Language Understanding, such as the statistical language model. Based on resonances and collisions between LLM context and SLM context, guardrails for the system output (e.g., automatically generated audio or textual responses to user requests) may be persistently adapted, and performance of the LLM may significantly improve over time.

This leads to more refined versions of LLMs, which may be referred to as system memory related LLM (e.g., system generated regulations and refined guardrails) or user memory related LLM (e.g., optimal guardrails for a logged in user). Incorrect results that were correctly classified by SLM shall be used for further improving self-evaluation learning for the LLM.

In some examples, a vehicle control module is configured to refine the performance of a generative AI/LLM, such as a model for providing responses to user voice requests in a vehicle, by working in tandem with statistical language models and a semantic classifier. Performance of a generative AI model may be verified using a baseline of natural language understanding techniques, such as using a statistical language model and semantic classifier. For example, the semantic classifier may provide sound verification of classified intents and respective/relevant entities.

Generative AI hallucinations may be reduced or minimized, while routing execution of identified user requests via an NLP model. The LLMs may be corrected and improved using a baseline from natural language models, such as a statistical language.

Example vehicle control modules may be configured to use an LLM output confidence score and decision making to route a user request to a generative AI model or large language model, and the confidence score may suggest using both models in tandem. A history of interaction with the generative AI models and LLMs may be used to develop manufacturer specific LLMs (e.g., with generated outputs corresponding to manufacturer specific commands), user-specific LLMs (e.g., with generated outputs corresponding to frequently requests from a particular user), etc. A feedback loop mechanism may be used for LLMs with correctly labeled and verified user speech (e.g., training data), for improved training and refined performance of LLMs for future user queries pertaining to a same context.

Some example embodiments may provide one or more benefits or advantages, such as reduced or minimized instances of generative AI model hallucinations, robust performance of Generative AI model using more task completion oriented closed loop training and refining of the LLM for a better user experience, a more effective way to adapt a ruleset to restrict and minimize hallucinations, highly effective and efficient natural language processing (e.g., by using a methodology that entails Generative AI working in tandem with natural language understanding models such as a statistical language model), an adaptive implementation for refining the generative AI LLMs as well as NLP models using crowd sourced data, etc.

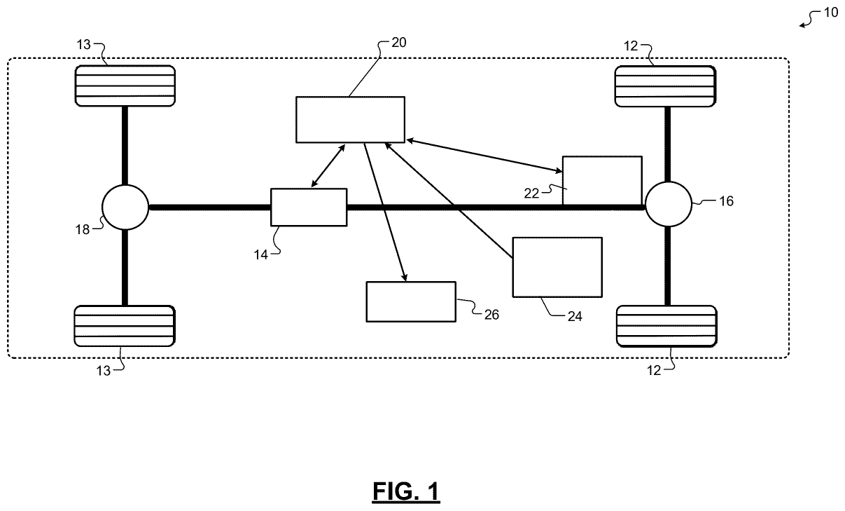

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, wheel position sensors, location sensors such as global positioning system (GPS) antennas, etc.). Some sensors may be configured to monitor current motion of the vehicle, acceleration of the vehicle, steering torque, etc.

As shown in FIG. 1, the vehicle 10 includes a user interface 22, a vehicle microphone 24, and a vehicle speaker 26. The user interface 22 may include any suitable button, dials, touchscreen, etc., to receive input from a driver or passenger of a vehicle. The user interface 22 may include a display for displaying text or images to a driver or passenger.

One or more vehicle microphones 24 may be located at any suitable position in the vehicle 10, and configured to detect speech from a driver or passenger of the vehicle 10. One or more vehicle speakers 26 may be located at any suitable position in the vehicle 10, to provide audio output signals to the driver or passenger.

For example, the user interface 22, vehicle microphone 24 and vehicle speaker 26 may be used for a voice command system, where a driver or passenger can use voice requests to obtain information and control different aspects of the vehicle. Various language models such as a generative AI model, large language model, statistical language model, etc., may be used to process user speech requests and then generate responses via text and/or audio signals.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

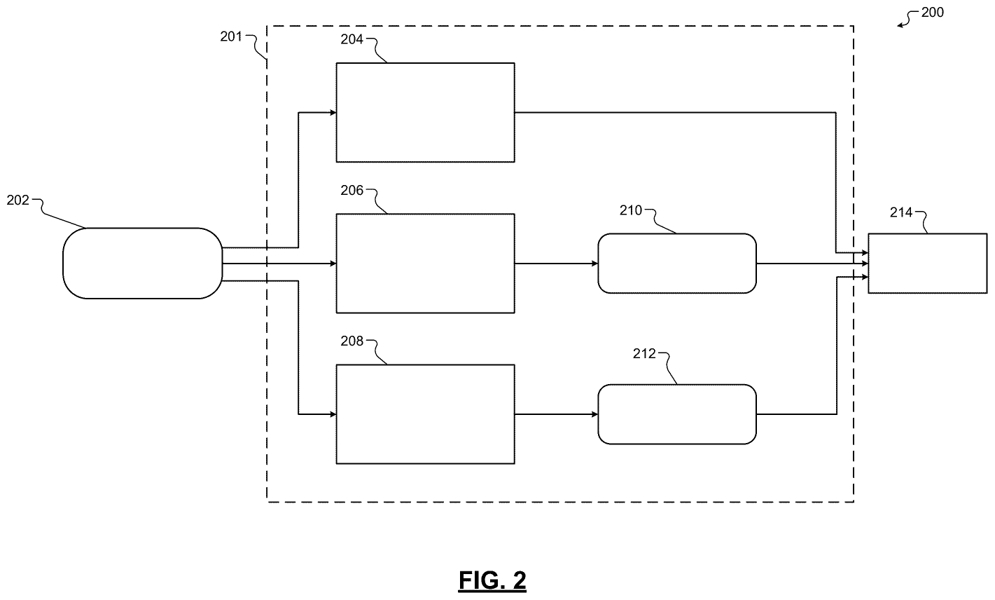

FIG. 2 is a functional block diagram of a system 200 including multiple language processing models 201 for use with the vehicle control module 20 of FIG. 1. For example, raw user speech 202 may be obtained via the vehicle microphone 24, and supplied to one or more language processing models 201.

As shown in FIG. 2, the multiple language processing models 201 may include an automatic speech recognition model 204, a large language model 206, and a natural language processing (NLP) model 208, such as a statistical language model (SLM).

The automatic speech recognition model 204 may be configured to translate acoustic user speech from a driver or passenger, into text for further speech processing. The large language model 206 may be a computation model configured to achieve general-purpose language generation and other natural language processing tasks such as classification, by learning statistical relationships from vast amounts of text during a computationally intensive self-supervised and semi-supervised training process. The large language model 206 may be used for text generation, a form of generative AI, by taking an input text and repeatedly predicting the next token or word.

In some examples, the large language model 206 may be an artificial neural networks that utilizes a transformer architecture, which may include a decoder-only transformer-based architecture which enables efficient processing and generation of large-scale text data. The large language model 206 may achieve results through prompt engineering, which involves crafting specific input prompts to guide the model's responses. The large language model 206 may acquire knowledge about syntax, semantics, and ontologies inherent in human language.

As shown in FIG. 2, the large language model 206 may be configured to generate an interim response 210, and the natural language processing model 208 may be configured to generate or use topic, entity and ruleset data 212 to produce output response. As explained further below, an audio output selector 214 may be configured to provide an audio or textual response to a user based on one or more (or a combination) of outputs of the automatic speech recognition model 204, the large language model 206, and the natural language processing model 208.

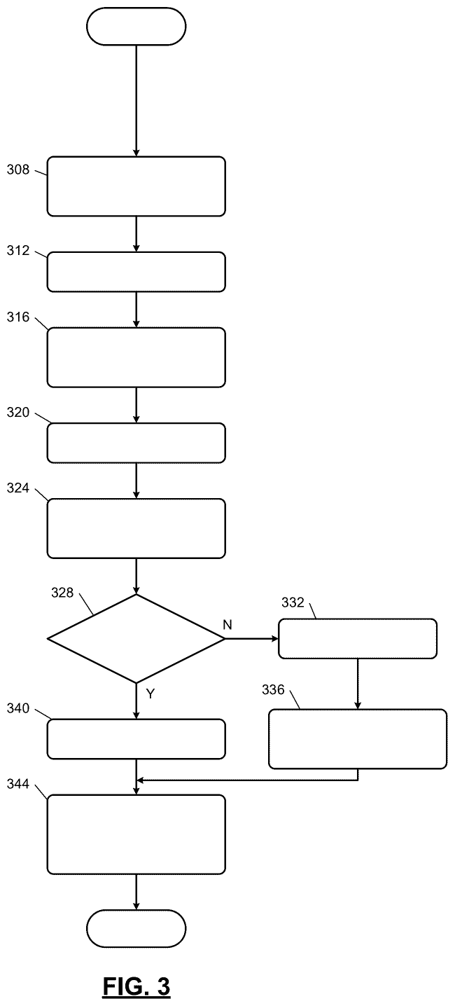

FIG. 3 is a flowchart depicting an example process for automated control of vehicle components based on user requests. The process may be performed by, for example, the vehicle control module 20 of FIG. 1, a mobile device of a user, another processing device associated with the vehicle 10 or the user, etc. At 304, the method begins by obtaining user speech, such as receiving speech from a driver or passenger of the vehicle 10 through the vehicle microphone 24 or user interface 22.

At 308, the vehicle control module is configured to process speech with an automatic speech recognition (ASR) model. For example, one or more trained models may be configured to convert audio speech signals into text values representing words spoken by a user.

At 312, the vehicle control module is configured to create dictation text. For example, based on the processing from the automatic speech recognition model, words spoken by the user may be recorded in text format suitable for processing by other language models. Any suitable ASR models or algorithms may be used for processing and converting user speech to text.

The vehicle control module is configured to process the text with a statistical language model (SLM) at 316. For example, the converted or dictation text may be supplied as input to any suitable statistical language model to determine an intent, context, etc. of the user request.

At 320, the vehicle control module is configured to process the text with a large language model (LLM). For example, the converted or dictation text may be supplied as input to any suitable large language model to determine an intent, context, etc. of the user request. In some examples, both the SLM and the LLM may be used to process the same converted text of the user speech, to generate outputs indicative of the user request from each respective model (e.g., for comparison, to check accuracy, to determine which model has provided a more useful output, etc.). Although FIG. 3 refers to an SLM and an LLM, other example embodiments may use other suitable generative artificial intelligence (AI) models, other suitable natural language processing (NLP) models, etc.

The vehicle control module is configured to generate a confidence score for based on evaluation of the LLM output, at 324. For example, embeddings of the LLM output may be compared to embeddings of the SLM output to predict how accurate or confident the LLM output is in producing a correct result or correct response to the user request.

At 328, the vehicle control module is configured to compare the LLM confidence score to a specified threshold (e.g., a threshold value indicative that the LLM output is predicted to be correct or accurate). If the LLM confidence score is above the threshold at 328, the vehicle control module is configured to provide a feedback prompt based on the LLM output at 340. For example, the vehicle speaker 26 or user interface 22 may provide an audio or textual response to the driver or passenger, based on the output of the LLM.

If the LLM confidence score is not greater than the specified threshold at 328, control proceeds to 332 to update a database of corrected labels. For example, if a low confidence score indicates that the LLM likely generated an inaccurate output, the system may fall back to using output from, e.g., the SLM model (where the SLM model has a higher confidence score indicating its output is more likely correct), while storing the output from the SLM model for use in training the LLM model.

At 336, the vehicle control module is configured to periodically train the LLM using the database of corrected labels. For example, after a specified time period (e.g., hourly, daily, weekly, monthly, etc.), or after a specified number of user requests (e.g., ten normal or low confidence score outputs of the LLM, 100 normal or low confidence score outputs of the LLM, etc.), the LLM model may be trained using the corrected labels from the database in order to make the LLM model more accurate. In this manner, outputs from the SLM (which may be considered as more likely to be correct when the SLM confidence score is higher than the LLM confidence score) may continue to update the LLM model to make the LLM output more refined and accurate over time.

At 344, the vehicle control module is optionally configured to automatically control one or more vehicle components according to a user request. For example, if the user request is to operate a navigation system of the vehicle, operate a communication or entertainment interface of the vehicle, change a driving setting or vehicle operation setting, etc., the vehicle control module may be configured to automatically change, adjust or modify operation of one or more components of the vehicle according to the processed user request.

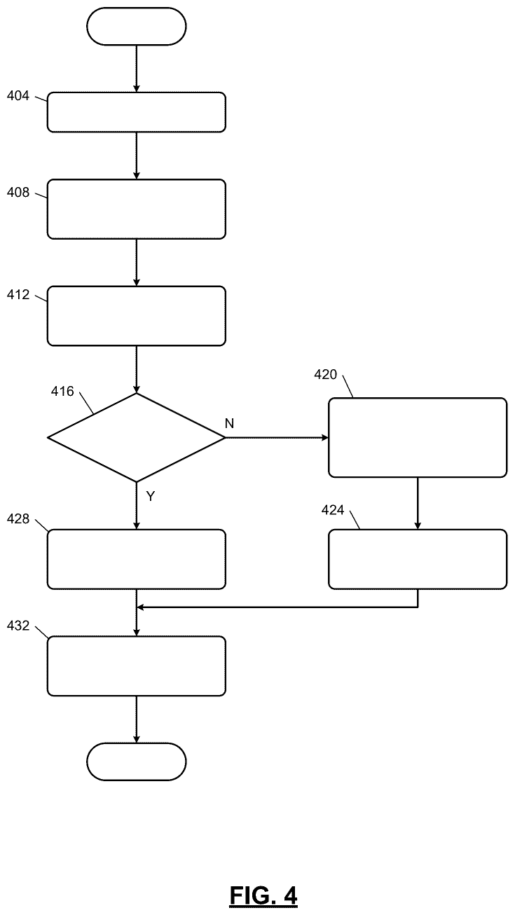

FIG. 4 is a flowchart depicting an example process for processing user speech using a large language model or a statistical language model. The process may be performed by, for example, the vehicle control module 20 of FIG. 1, a mobile device of a user, another processing device associated with the vehicle 10 or the user, etc.

At 404, the method begins by obtaining user speech (e.g., an utterance by a driver or passenger of the vehicle), such as via the vehicle microphone 24 of the vehicle user interface 22. The user speech is then processed at 408 using an automatic speech recognition (ASR) model.

At 412, the vehicle control module is configured to classify the speech query as a deterministic speech query or a probabilistic speech query. For example, a deterministic speech query may be a more straightforward request or command to use a vehicle component in a certain way (e.g., “turn on radio” or “call my spouse”). A probabilistic speech request may require more complicated processing and prediction for the user request, such as asking for a weather forecast at a future time at a different location, asking for a specific type of restaurant near a different location, etc. Any suitable classifier may be used to determine whether the user speech query is deterministic or probabilistic.

If the user speech query is classified as probabilistic at 416, control proceeds to 428 to route the speech query to a large language model. For example, large language models such as generative AI may be better suited to handle more complex probabilistic user speech queries.

If the user speech query is classified as deterministic at 416, control proceeds to 420 to route the speech query to a statistical language model and semantic classifier. The statistical language model may be better suited to handle more straightforward or simple speech query requests. The vehicle control module may determine a confidence score for the output of the SLM at 424, using any suitable techniques for output confidence score calculation for SLM models.

At 432, the vehicle control module is configured to generate a likelihood accuracy score for the LLM output. For example, embeddings of the LLM output may be compared to embeddings of the SLM output and the SLM confidence score, to determine whether the LLM output should have a similar or different likelihood accuracy score as the SLM confidence score (e.g., based on whether embeddings in outputs of each model match, etc.). Although FIG. 4 refers to an SLM and an LLM, other example embodiments may use other suitable generative artificial intelligence (AI) models, other suitable natural language processing (NLP) models, etc.

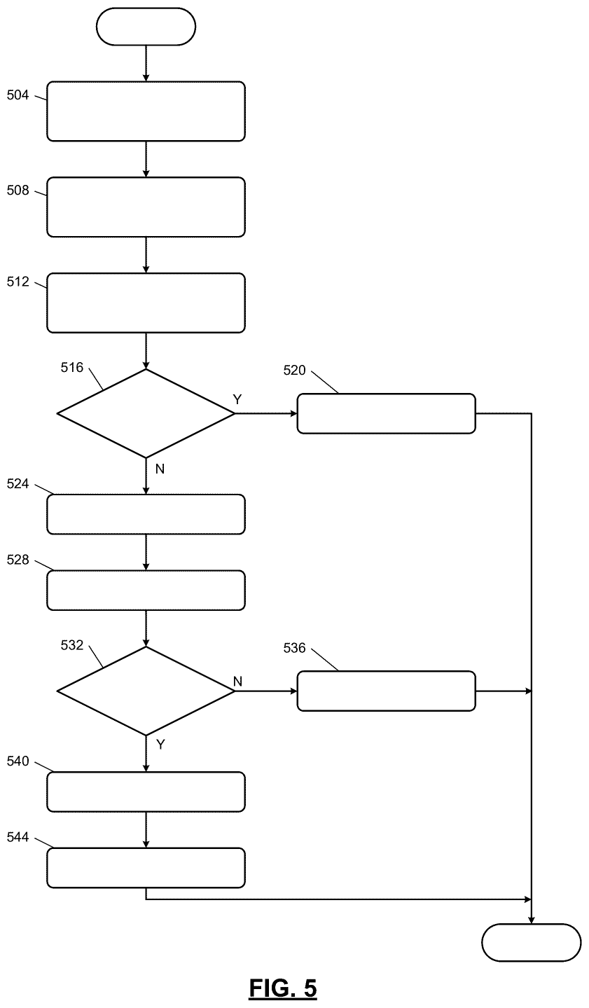

FIG. 5 is a flowchart depicting an example process for comparing confidence scores of a large language model and a statistical language model. The process may be performed by, for example, the vehicle control module 20 of FIG. 1, a mobile device of a user, another processing device associated with the vehicle 10 or the user, etc.

At 504, the method begins by obtaining a sequence of tokens from a large language model. For example, any suitable tokens from the large language model output may be accessed to generate the likelihood score. The vehicle control module is configured to sum the token likelihood values to generate an overall likelihood score at 508. For example, tokens, embeddings, etc. of the LLM may be compared to, e.g., tokens or embeddings of the SLM or another model, to determine an accuracy likelihood for each LLM token. Those individual likelihood values for each token may be summed to generate an overall output likelihood score for the LLM output.

At 512, the vehicle control module is configured to determine an LLM confidence score based on the summed token likelihood values. The LLM confidence score is compared to a specified threshold at 516. The specified threshold may be a confidence score value indicative that the output of the LLM is likely accurate or correct.

If the LLM confidence score is greater than the specified threshold at 516, control proceeds to 520 to output a prompt from the LLM to the user. For example, the system may generate an audio or textual response to the user based on the LLM output, to be provided through the vehicle speaker 26 or user interface 22.

If the confidence score is not greater than the specified threshold at 516, control proceeds to 524 to obtain a statistical language model confidence score at 524. The vehicle control module then compares the confidence scores from the SLM and the LLM at 528. Although FIG. 5 refers to an SLM and an LLM, other example embodiments may use other suitable generative artificial intelligence (AI) models, other suitable natural language processing (NLP) models, etc.

If outputs of the LLM and SLM have matching intent values and matching entities at 532, control proceeds to 536 to output a response from the SLM model. If outputs of the LLM and SLM do not have matching intent values or entities, control proceeds to 540 to augment the confidence score for the LLM output. The vehicle control module is configured to output the LLM response and engage a user in N-turn dialog going forward.

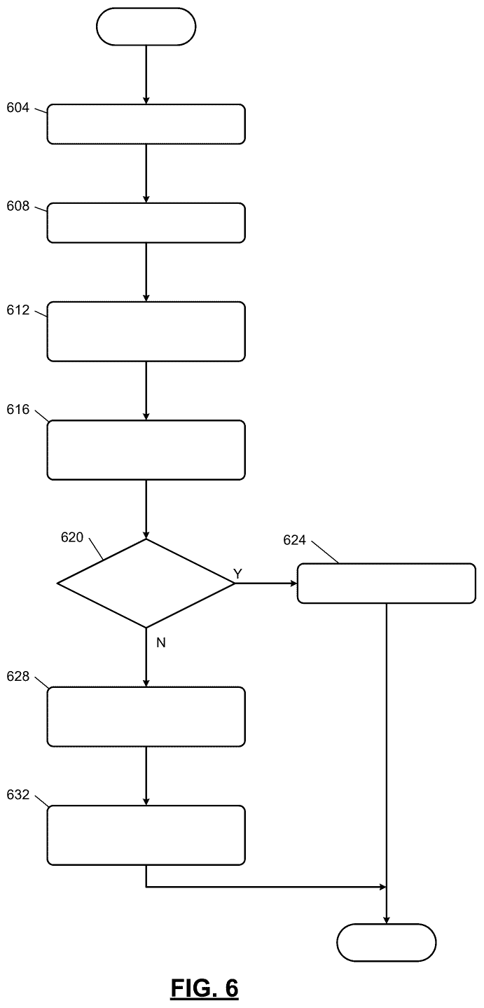

FIG. 6 is a flowchart depicting an example process for using guardrail data to restrict output of a large language model. The process may be performed by, for example, the vehicle control module 20 of FIG. 1, a mobile device of a user, another processing device associated with the vehicle 10 or the user, etc.

At 604, the method begins by accessing vehicle location data, such as via a global positioning system (GPS) antenna, a specified region assigned to the vehicle, etc. The vehicle location data may specify, for example, a region the vehicle is located in, a specific city, state, county, country, etc.

At 608, the vehicle control module is configured to obtain disallowed topic data. For example, discussion of certain political topics may not be allowed in different geographic regions, or other sensitive topics that vary depending on location. The disallowed topic data may specify information that should not be included in output of a language model, which may vary depending on geographic location of the vehicle.

The vehicle control module is configured to generate an interim response using a generative AI large language model, at 612. For example, the user speech request may be provided to the LLM to generate an interim response, but the interim response is not output back to the user until further processing and verification is performed.

For example, at 616 the vehicle control module is configured to compare the interim response to system ruleset data and specified guardrail data. The ruleset and guardrail data may include responses, topics, information, etc., that the LLM should not output back to the user. This data may be defined, updated, etc., over time, by a system administrator, by a user of the vehicle, etc.

After comparing the interim response to the system ruleset data and guardrail data, if the interim response is a permitted context at 620, control proceeds to 624 to output the interim response to a user. For example, after verification of the interim response as a permitted output, the interim response may be output to the user via an audio signal or text using the vehicle speaker 26 or user interface 22.

If the interim response is not in a permitted context at 620 (e.g., because it includes a disallowed sensitive topic), control proceeds to 628 to update prompt text using a natural language generation model. For example, another language model may be used to generate a more standard response that does not include disallowed sensitive topic information, compared to the interim response output by the generative AI model.

At 632, the vehicle control module is configured to transmit corrective input to the large language model for future corrections. For example, a replacement message or revised output may be supplied to the large language model which does not include a disallowed topic, so the large language model may provide responses in the future that do not include disallowed topics.

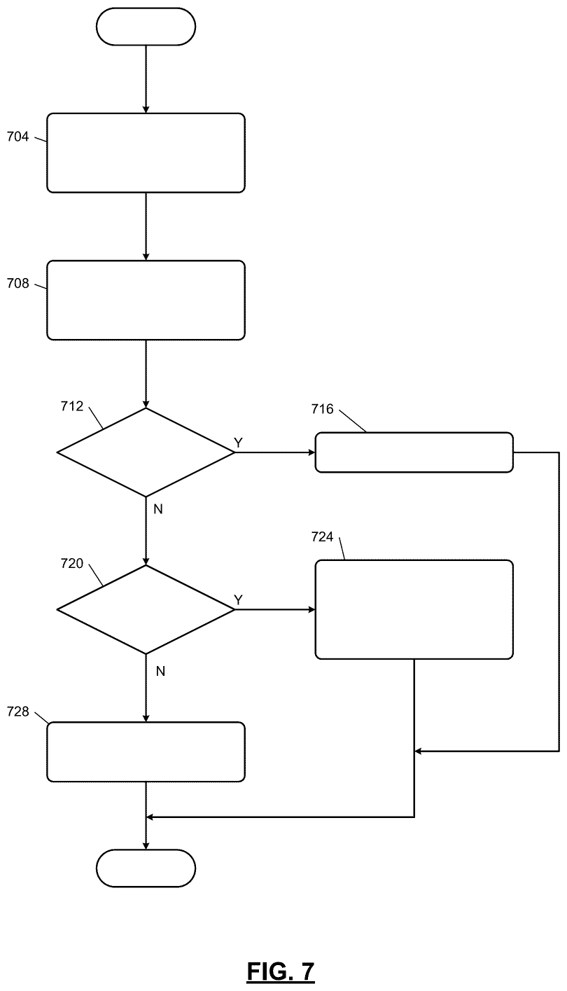

FIG. 7 is a flowchart depicting an example process for selecting between a large language model and a statistical language model based on output confidence scores. The process may be performed by, for example, the vehicle control module 20 of FIG. 1, a mobile device of a user, another processing device associated with the vehicle 10 or the user, etc.

At 704, the method begins by processing user speech with a large language model and a statistical language model. Although FIG. 7 refers to an SLM and an LLM, other example embodiments may use other suitable generative artificial intelligence (AI) models, other suitable natural language processing (NLP) models, etc.

At 708, control is configured to compare the LLM output embeddings to the SLM output embeddings to generate a confidence score. If the confidence score is greater than a high threshold value, control proceeds to 716 to respond to the user request using the LLM output.

If the confidence score is lower than the high threshold value at 712, control determines at 720 whether the confidence score is above a low threshold value. In some examples, the high threshold value may indicate a sufficient likelihood of an accurate LLM output that the LLM output alone may be provided to the user.

The low threshold value may indicate a moderate likelihood of an accurate LLM output, where the LLM output can be used in combination with output from another model. For example, if the confidence score is above the low threshold value at 720, control proceeds to 724 to respond to the user request using a mixed approach regression, based on a combination of the LLM output and the SLM output.

If the confidence score is below the low threshold value at 720, control proceeds to 728 to respond to the user request using the SLM output, where the LLM output may not be used at all. In the example of FIG. 7, multiple thresholds allow for use of only the LLM output, a combination of LLM output and SLM output, or SLM output alone, based on varying levels of confidence in a likelihood of accuracy of the LLM output.

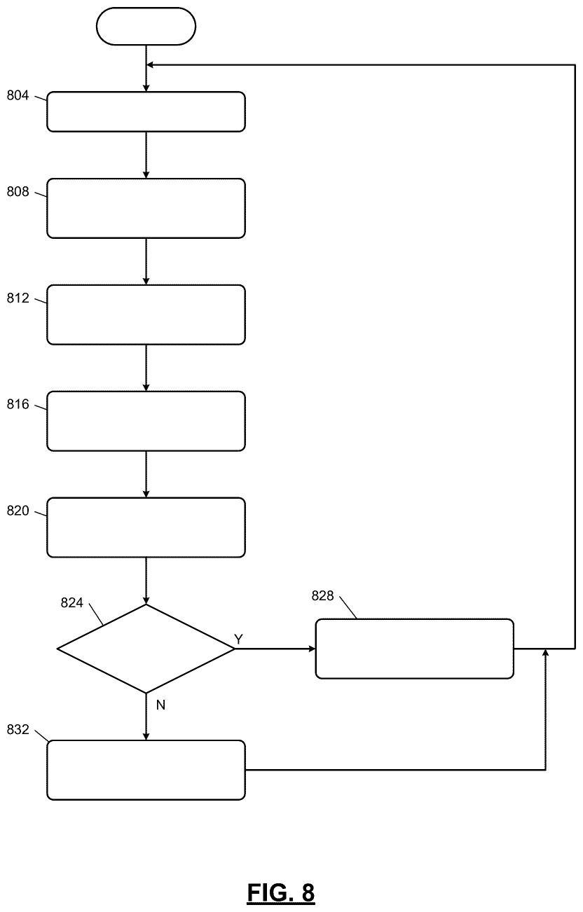

FIG. 8 is a flowchart depicting an example process for processing speech including performing acoustic emotion classification. The process may be performed by, for example, the vehicle control module 20 of FIG. 1, a mobile device of a user, another processing device associated with the vehicle 10 or the user, etc.

At 804, the process begins by obtaining user speech, such as via the vehicle microphone 24 or user interface 22. The vehicle control module is configured to transcribe the speech using automated speech recognition, at 808. Any suitable ASR implementations may be used.

At 812, the vehicle control module is configured to detect user frustration and/or emotion values, such as by using an orthographic channel. For example, any suitable frustration detection or emotion detection algorithms may be used to process the user speech and predict whether words uttered by the user are indicative that the user is getting frustrated, angry or upset.

The vehicle control module is configured to perform acoustic emotion classification on the user speech at 816. For example, the audio signals of the user speech may be processed to determine whether the tone of the user's voice is indicating frustration, anger, etc. Any suitable acoustic emotion classification algorithm may be used in various examples.

At 820, the vehicle control module is configured to compare the user emotion value to a specified value. For example, the textual frustration detection result and the acoustic emotion detection result may be combined, compared to thresholds individually, etc., to determine whether the user is currently frustrated or angry.

If the emotion value is greater than the specified threshold at 824 (e.g., indicating that the user is still experiencing pleasant or neutral emotions), control proceeds to 828 to continue using the LLM for additional dialog with the user. If the emotion value is less than the specified threshold at 824 (e.g., indicating that the user is experiencing frustration or anger from interactions with the LLM responses), control proceeds to 832 to switch to an N-gram based language model or a finite state grammar (FSG) model to continue dialog with the user. In this manner, the system may detect if a user is getting frustrated with responses from a generative AI model, and switch to a more deterministic language response model at that point to avoid further user frustration.

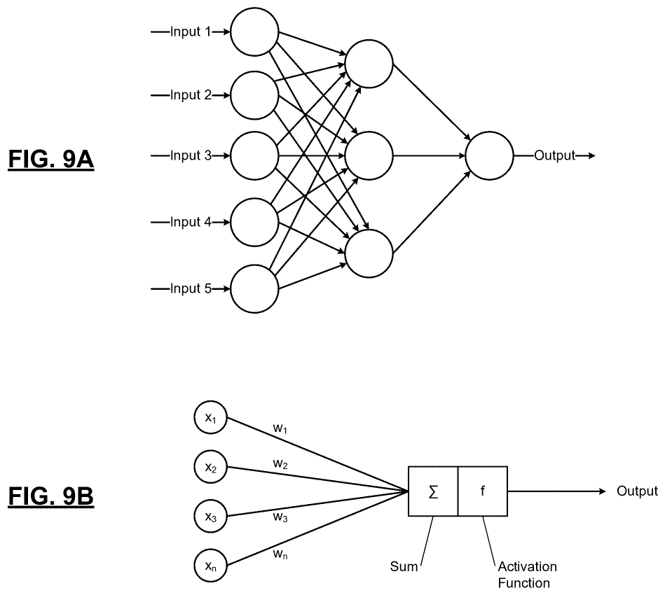

FIGS. 9A and 9B show an example of a neural network used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer and receives raw input data. Each successive layer modifies outputs from a preceding layer and sends them to a next layer. Each successive layer optionally applies non-linear transformation functions to the outputs from a preceding layer before sending them to the next layer. The last layer is the output layer and produces output of the system.

FIG. 9A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 9B). In the input layer, the number of neurons equals number of features (columns) in a dataset. The output layer may have multiple continuous outputs.

The layers between the input and output layers are hidden layers. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure performance of a neural network model. For example, root mean squared error (RMSE) measures the average distance between observed values and model predictions. Coefficient of Determination (R2) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit). The neural network can receive inputs, e.g., vectors, which can be used to generate models that can be used with language processing, such as speech inputs from a driver or passenger of a vehicle.

Although FIGS. 9A and 9B illustrate example neural networks, other embodiments may include other types of models, or more specific neural network types. For example, large language models may use transformers, long short-term memory (LSTM) models may be used in some examples, etc.

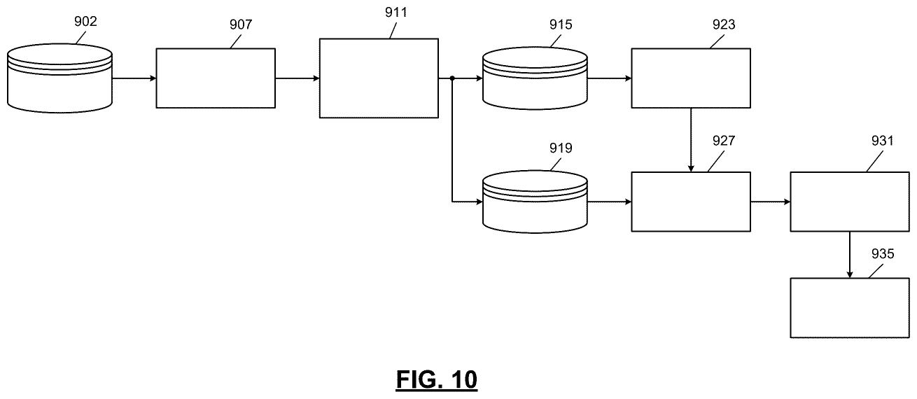

FIG. 10 illustrates an example process for generating a machine learning model. At 907, control obtains data from a database 902 (e.g., a data warehouse). The data may include any suitable data for developing machine learning models.

At 911, control separates the data obtained from the database 902 into training data 915 and test data 919. The training data 915 is used to train the model at 923, and the test data 919 is used to test the model at 927. Typically, the set of training data 915 is selected to be larger than the set of test data 919, depending on the desired model development parameters. For example, the training data 915 may include about seventy percent of the data acquired from the database 902, about eighty percent of the data, about ninety percent, etc. The remaining thirty percent, twenty percent, or ten percent, is then used as the test data 919.

Separating a portion of the acquired data as test data 919 allows for testing of the trained model against actual output data, to facilitate more accurate training and development of the model at 923 and 927. The model may be trained at 923 using any suitable machine learning model techniques, including those described herein, such as random forest, generalized linear models, decision tree, and neural networks.

At 931, control evaluates the model test results. For example, the trained model may be tested at 927 using the test data 919, and the results of the output data from the tested model may be compared to actual outputs of the test data 919, to determine a level of accuracy. The model results may be evaluated using any suitable machine learning model analysis, such as the example techniques described further below.

After evaluating the model test results at 931, the model may be deployed at 935 if the model test results are satisfactory. Deploying the model may include using the model to make predictions for a large-scale input dataset with unknown outputs. If the evaluation of the model test results at 931 is unsatisfactory, the model may be developed further using different parameters, using different modeling techniques, using other model types, etc. The machine learning model method of FIG. 10 can receive inputs, e.g., vectors, which can be used with language processing, such as speech inputs from a driver or passenger of a vehicle. In some example embodiments, a machine learning model may be trained via unsupervised learning, such as training generative AI models or LLMs.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle user interface system comprising:
at least one vehicle speaker configured to generate audio signals within a vehicle;
a vehicle user interface including a screen configured to display text;
at least one vehicle microphone configured to capture speech of a vehicle occupant; and
a vehicle control module configured to:
obtain speech input from the vehicle occupant via the at least one vehicle microphone;
classify the speech input as a deterministic speech request or a probabilistic speech request;
in response to the speech input being classified as a deterministic speech request, process the speech input using a statistical language model (SLM) to generate an SLM output;
in response to the speech input being classified as a probabilistic speech request, process the speech input using a large language model (LLM) to generate an LLM output; and
generate at least one of an audio response output using the at least one vehicle speaker or a textual response output using the screen of the vehicle user interface, wherein the audio response output or the textual response output is based on the SLM output generated by the statistical language model or the LLM output generated by the large language model.

2. The vehicle user interface system of claim 1, wherein the vehicle control module is configured to automatically modify operation of at least one vehicle component in response to the speech input including an occupant request to operate the at least one vehicle component.

3. The vehicle user interface system of claim 2, wherein automatically modifying operation of the at least one vehicle component includes at least one of initiating a phone call through the vehicle user interface, sending a message through the vehicle user interface, activating an entertainment function of the vehicle user interface, or changing at least one driving setting of the vehicle.

4. The vehicle user interface system of claim 1, wherein the vehicle control module is configured to:
calculate a confidence score for the LLM output of the large language model;
compare the confidence score to a specified confidence score threshold indicative of an accurate LLM output likelihood; and
generate the audio response output or the textual response output based on the SLM output in response to the confidence score being below the specified confidence score threshold.

5. The vehicle user interface system of claim 4, wherein calculating the confidence score for the LLM output includes comparing embeddings of tokens of the LLM output to embeddings of the SLM output of the statistical language model.

6. The vehicle user interface of claim 4, wherein the specified confidence score threshold is a first confidence score threshold, and the vehicle control module is configured to:
compare the confidence score to a second confidence score threshold, the second confidence score threshold greater than the first confidence score threshold; and
generate the audio response output or the textual response output based on a combination of the LLM output and the SLM output in response to the confidence score being greater than the first confidence score threshold and below the second confidence score threshold.

7. The vehicle user interface system of claim 4, wherein the vehicle control module is configured to:
update a database of corrected output labels, based on the SLM output of the statistical language model, in response to the confidence score being below the specified confidence score threshold; and
retrain the large language model using the database of corrected output labels.

8. The vehicle user interface system of claim 1, wherein the vehicle control module is configured to:
obtain model output guardrail data from a database of stored sensitive output topic data;
process the speech input using the large language model (LLM) to generate an interim output response;
compare the interim output response to the model output guardrail data; and
inhibit output of the interim output response in response to the interim output response including a disallowed topic of the model output guardrail data.

9. The vehicle user interface system of claim 8, wherein:
the vehicle control module is configured to obtain a current geographic location of the vehicle;
the stored sensitive output topic data in the database varies by geographic location; and
comparing the interim output response to the model output guardrail data includes comparing the interim output response to only sensitive output topic data corresponding to the current geographic location of the vehicle.

10. The vehicle user interface system of claim 1, wherein the vehicle control module is configured to:
determine a vehicle occupant emotion score based on the speech input obtained from the vehicle occupant;
compare the vehicle occupant emotion score to a specified emotion score threshold indicative of vehicle occupant frustration of interacting with output of the large language model; and
generate the audio response output or the textual response output based on the SLM output instead of the LLM output in response to the vehicle occupant emotion score exceeding the specified emotion score threshold.

11. The vehicle user interface system of claim 10, wherein determining the vehicle occupant emotion score includes:
generating a first vehicle occupant emotion score based on textual processing of the speech input;
generating a second vehicle occupant emotion score based on acoustic processing of the speech input; and
combining the first vehicle occupant emotion score and the second vehicle occupant emotion score to generate an overall vehicle occupant emotion score.

12. The vehicle user interface system of claim 1, wherein the vehicle control module is configured to convert audio signals of the speech input to text using automatic speech recognition (ASR).

13. A method of operating a vehicle user interface system, the method comprising:
obtaining speech input from a vehicle occupant using at least one vehicle microphone;
classifying the speech input as a deterministic speech request or a probabilistic speech request;
in response to the speech input being classified as a deterministic speech request, processing the speech input using a statistical language model (SLM) to generate an SLM output;
in response to the speech input being classified as a probabilistic speech request, processing the speech input using a large language model (LLM) to generate an LLM output; and
generating at least one of an audio response output using at least one vehicle speaker or a textual response output using a screen of a vehicle user interface, wherein the audio response output or the textual response output is based on the SLM output generated by the statistical language model or the LLM output generated by the large language model.

14. The method of claim 13, further comprising automatically modifying operation of at least one vehicle component in response to the speech input including an occupant request to operate the at least one vehicle component.

15. The method of claim 14, wherein automatically modifying operation of the at least one vehicle component includes at least one of initiating a phone call through the vehicle user interface, sending a message through the vehicle user interface, activating an entertainment function of the vehicle user interface, or changing at least one driving setting of the vehicle.

16. The method of claim 13, further comprising:
calculating a confidence score for the LLM output of the large language model;
comparing the confidence score to a specified confidence score threshold indicative of an accurate LLM output likelihood; and
generating the audio response output or the textual response output based on the SLM output in response to the confidence score being below the specified confidence score threshold.

17. The method of claim 16, wherein calculating the confidence score for the LLM output includes comparing embeddings of tokens of the LLM output to embeddings of the SLM output of the statistical language model.

18. The method of claim 16, wherein the specified confidence score threshold is a first confidence score threshold, and the method further comprises:
comparing the confidence score to a second confidence score threshold, the second confidence score threshold greater than the first confidence score threshold; and
generating the audio response output or the textual response output based on a combination of the LLM output and the SLM output in response to the confidence score being greater than the first confidence score threshold and below the second confidence score threshold.

19. The method of claim 16, further comprising:
updating a database of corrected output labels, based on the SLM output of the statistical language model, in response to the confidence score being below the specified confidence score threshold; and
retraining the large language model using the database of corrected output labels.

20. The method of claim 13, further comprising:
obtaining model output guardrail data from a database of stored sensitive output topic data;
processing the speech input using the large language model (LLM) to generate an interim output response;
comparing the interim output response to the model output guardrail data; and
inhibiting output of the interim output response in response to the interim output response including a disallowed topic of the model output guardrail data.
